(19) United States
(12) Patent Application Publication
(10) Pub. No.: US 2025/0325068 A1
(43) Pub. Date: Oct. 23, 2025

(54) Article of Footwear Having Increased Torsional Stiffness

(71) Applicant: Cole Haan LLC, Greenland, NH (US)

(72) Inventors: Xiao Jun, Hai Phong City (VN); Raghu Yalamanchili, Hai Phong City (VN); Narendran Jayavel, Hai Phong City (VN); Aubert Shepherd, Greenland, NH (US)

(21) Appl. No.: 19/185,719

(22) Filed: Apr. 22, 2025

(30) Foreign Application Priority Data
Apr. 23, 2024 (CN) 202410494217.6

(51) Int. Cl. A43B 13/12; A43B 13/32; B33Y 80/00

(52) U.S. Cl. CPC A43B 13/12; A43B 13/32; B33Y 80/00

(57) ABSTRACT

A shoe comprising a sole, an upper secured to the sole, and a welt. The welt comprises at least one piece separate from the sole and upper. The welt is adjacent both the sole and the upper and is secured to at least one of the sole and the upper. The sole is a 3-D printed sole comprising a plurality of interconnected cells. Each cell of the plurality of interconnected cells is connected to at least one adjacent cell of the plurality of interconnected cells. The shoe has a torsional stiffness at least 100% greater than the torsional stiffness of a first comparison shoe. The first comparison shoe is identical to the shoe except the first comparison shoe is devoid of a welt. The torsional stiffness is a torque sufficient to rotate the heel-widest portion ten degrees (10°) from an un-torqued condition as the ball-widest portion is held stationary.

### CROSS-REFERENCE TO RELATED APPLICATIONS

This application claims priority to Chinese Application No. CN 202410494217.6, filed Apr. 23, 2024, the disclosure of which is incorporated by referenced herein.

### STATEMENT REGARDING FEDERALLY SPONSORED RESEARCH OR DEVELOPMENT

Not Applicable.

### APPENDIX

Not Applicable.

### BACKGROUND OF THE INVENTION

### Field of the Invention

This invention pertains to an article of footwear having an increased torsional stiffness.

### SUMMARY

One aspect of the disclosure is a shoe comprising a sole, an upper secured to the sole, and a welt. The welt comprises at least one piece separate from the sole and separate from the upper. The welt is adjacent both the sole and the upper and is secured to at least one of the sole and the upper. The sole has a sole heel end and a sole toe end. The sole extends along a shoe axis from the sole heel end to the sole toe end. The sole has a sole heel region, a sole midfoot region, a sole forefoot region, a sole ball region, a sole metatarsal region, and a sole toe region. The sole heel region extends longitudinally from the sole heel end to the sole midfoot region. The sole midfoot region extends longitudinally from the sole heel region to the sole forefoot region. The sole forefoot region extends longitudinally from the sole midfoot region to the sole ball region. The sole ball region extends longitudinally from the sole forefoot region to the sole metatarsal region. The sole metatarsal region extends longitudinally from the sole ball region to the sole toe region. The sole toe region extends longitudinally from the sole metatarsal region to the sole toe end. The sole has a lateral side that extends from the sole heel region to the sole toe region and a medial side that extends from the sole heel region to the sole toe region. The sole extends transversely from the lateral side to the medial side. The sole heel region has a lateral heel portion and a medial heel portion. The sole midfoot region has a lateral midfoot portion and a medial midfoot portion. The sole forefoot region has a lateral forefoot portion and a medial forefoot portion. The sole ball region has a lateral ball portion and a medial ball portion. The sole metatarsal region has a lateral metatarsal portion and a medial metatarsal portion. The sole toe region has a lateral toe portion and a medial toe portion. The sole has a heel-widest portion. The heel-widest portion is the portion of the sole that has the greatest width in the sole heel region from the medial side to the lateral side. The sole has a ball-widest portion. The ball-widest portion is the portion of the sole that has the greatest width in the sole ball region from the medial side of the sole to the lateral side of the sole. The sole is a 3-D printed sole comprising a plurality of interconnected cells. Each cell of the plurality of interconnected cells is connected to at least one adjacent cell of the plurality of interconnected cells. The sole has a sole top surface and a sole bottom surface. The sole has a periphery extending between the sole top surface and the sole bottom surface. Said shoe has a torsional stiffness. The torsional stiffness of said shoe is at least 100% greater than the torsional stiffness of a first comparison shoe. The first comparison shoe is identical to said shoe except the first comparison shoe is devoid of a welt. The torsional stiffness is a torque sufficient to rotate the heel-widest portion ten degrees (10°) from an un-torqued condition as the ball-widest portion is held stationary.

Another aspect of the disclosure is a shoe comprising a sole, an upper secured to the sole, a welt, and a heel clip. The welt comprises at least one piece separate from the sole and separate from the upper. The welt is adjacent both the sole and the upper and is secured to at least one of the sole and the upper. The heel clip comprises at least one piece separate from the sole, separate from the upper, and separate from the welt. The heel clip is secured to at least one of the sole and the upper in at least the sole heel region. The sole has a sole heel end and a sole toe end. The sole extends along a shoe axis from the sole heel end to the sole toe end. The sole has a sole heel region, a sole midfoot region, a sole forefoot region, a sole ball region, a sole metatarsal region, and a sole toe region. The sole heel region extends longitudinally from the sole heel end to the sole midfoot region. The sole midfoot region extends longitudinally from the sole heel region to the sole forefoot region. The sole forefoot region extends longitudinally from the sole midfoot region to the sole ball region. The sole ball region extends longitudinally from the sole forefoot region to the sole metatarsal region. The sole metatarsal region extends longitudinally from the sole ball region to the sole toe region. The sole toe region extends longitudinally from the sole metatarsal region to the sole toe end. The sole has a lateral side extending from the sole heel region to the sole toe region and a medial side extending from the sole heel region to the sole toe region. The sole extends transversely from the lateral side to the medial side. The sole heel region has a lateral heel portion and a medial heel portion. The sole midfoot region has a lateral midfoot portion and a medial midfoot portion. The sole forefoot region has a lateral forefoot portion and a medial forefoot portion. The sole ball region has a lateral ball portion and a medial ball portion. The sole metatarsal region has a lateral metatarsal portion and a medial metatarsal portion. The sole toe region has a lateral toe portion and a medial toe portion. The sole has a heel-widest portion. The heel-widest portion is the portion of the sole having the greatest width in the sole heel region from the medial side to the lateral side. The sole has a ball-widest portion. The ball-widest portion is the portion of the sole having the greatest width in the sole ball region from the medial side of the sole to the lateral side of the sole. The sole is a 3-D printed sole comprising a plurality of interconnected cells. Each cell of the plurality of interconnected cells is connected to at least one adjacent cell of the plurality of interconnected cells. The sole has a sole top surface and a sole bottom surface. The sole has a periphery extending between the sole top surface and the sole bottom surface. Said shoe has a torsional stiffness. The torsional stiffness of said shoe being at least 100% greater than the torsional stiffness of a second comparison shoe. The second comparison shoe is identical to said shoe except the second comparison shoe is devoid of a welt and devoid of a heel clip. The torsional stiffness is a torque sufficient to rotate the heel- widest portion, about the shoe axis, ten degrees) (10° from an un-torqued condition as the ball-widest portion is held stationary.

Further features and advantages, as well as the operation, are described in detail below with reference to the accompanying drawings.

### BRIEF DESCRIPTION OF THE DRAWINGS

FIG. 1 is a perspective view of a shoe.

FIG. 2 is a perspective view of the sole of the shoe of FIG. 1.

FIG. 3a is a top view of the sole of the shoe of FIG. 1.

FIG. 3b is a bottom view of the sole of the shoe of FIG. 1.

FIG. 4a is a medial side view of the sole of the shoe of FIG. 1.

FIG. 4b is a lateral side view of the sole of the shoe of FIG. 1.

FIG. 5a is a front view of the sole of the shoe of FIG. 1.

FIG. 5b is a rear view of the sole of the shoe of FIG. 1.

FIG. 6 is a perspective view of a comparison shoe.

FIG. 7a is a schematic view of another embodiment of a shoe having its torsional stiffness measured.

FIG. 7b is a rear view of the shoe of FIG. 7a at 0 degrees of rotation.

FIG. 7c is a rear view of the shoe of FIG. 7a at 5 degrees of rotation.

FIG. 7d is a rear view of the shoe of FIG. 7a at 10 degrees of rotation.

FIG. 7e is a schematic view of the testing process utilized to measure the shoe of FIG. 7a's torsional stiffness.

FIG. 7f is a bottom view of the shoe of FIG. 7a prior to rotational stiffness testing.

FIG. 8 is a perspective view of another embodiment of a shoe.

FIG. 9 is a comparison view showing the soles of a comparison shoe, a shoe having a welt, and a shoe having a welt and a heel clip.

FIG. 10 is a further embodiment of a shoe.

FIG. 11 is a further embodiment of a shoe.

Reference numerals in the written specification and in the figures indicate corresponding items.

### DETAILED DESCRIPTION

An embodiment of a shoe in accordance with the present disclosure is indicated generally by reference number 20. The shoe 20 comprises a sole 22, an upper 24 secured to the sole, and a welt 26.

The upper 24 may comprise a medial side 24M or a lateral side 24L.

The welt 26 comprises at least one piece separate from the sole 22 and separate from the upper 24. The welt 26 is adjacent both the sole 22 and the upper 24 and is secured to at least one of the sole and the upper. The welt 26 may be secured to both the sole 22 and the upper 24. The welt 26 may be bonded to the sole 22 and/or upper 24 by adhesive. Alternatively, or in addition, the welt may be secured to the sole 22 and/or the upper 24 by stitching. The welt 26 may constitute a single, one-piece member. The welt 26 may comprise leather or salpa. Alternatively, the welt 26 may comprise a polymeric material such as ethylene-vinyl-acetate (EVA) or thermoplastic polyurethane (TPU). The welt 26 may comprise a plurality of welt slits. The welt 26 may be a storm welt.

The sole 22 has a sole heel end 28 and a sole toe end 30. The sole 22 extends along a shoe axis X from the sole heel end 28 to the sole toe end 30. The sole 22 has a sole heel region 32, a sole midfoot region 34, a sole forefoot region 36, a sole ball region 38, a sole metatarsal region 40, and a sole toe region 42. The sole heel region 32 extends longitudinally from the sole heel end 28 to the sole midfoot region 34. The sole midfoot region 34 extends longitudinally from the sole heel region 32 to the sole forefoot region 36. The sole forefoot region 36 extends longitudinally from the sole midfoot region 34 to the sole ball region 38. The sole ball region 38 extends longitudinally from the sole forefoot region 36 to the sole metatarsal region 40. The sole metatarsal region 40 extends longitudinally from the sole ball region 38 to the sole toe region 42. The sole toe region 42 extends longitudinally from the sole metatarsal region 40 to the sole toe end 30.

The sole 22 has a lateral side 22L that extends from the sole heel region 32 to the sole toe region 42 and a medial side 22M that extends from the sole heel region to the sole toe region. The sole 22 extends transversely from the lateral side 22L to the medial side 22M. The sole heel region 32 has a lateral heel portion 32L and a medial heel portion 32M. The sole midfoot region 34 has a lateral midfoot portion 34L and a medial midfoot portion 34M. The sole forefoot region 36 has a lateral forefoot portion 36L and a medial forefoot portion 36M. The sole ball region 38 has a lateral ball portion 38L and a medial ball portion 38M. The sole metatarsal region 40 has a lateral metatarsal portion 40L and a medial metatarsal portion 40M. The sole toe region 42 has a lateral toe portion 42L and a medial toe portion 42M.

The sole 22 has a heel-widest portion 44. The heel-widest portion 44 is the portion of the sole 22 that has the greatest width in the sole heel region 32 from the medial side 32M to the lateral side 32L.

The sole 22 has a ball-widest portion 46. The ball-widest portion 46 is the portion of the sole 22 that has the greatest width in the sole ball region 38 from the medial side 38M of the sole to the lateral side 38L of the sole.

The sole 22 is a 3-D printed sole comprising a plurality of interconnected cells 48. Each cell of the plurality of interconnected cells 48 is connected to at least one adjacent cell of the plurality of interconnected cells. The sole 22 may be 3-D printed via stereolithography (SLA), selective laser sintering (SLS), fused deposition modeling (FDM), hindered asynchronous light synthesis (HALS), and the like.

The sole 22 has a sole top surface 50 and a sole bottom surface 52. The sole 22 has a periphery 54 extending between the sole top surface 50 and the sole bottom surface 52.

Said shoe 20 has a torsional stiffness. The torsional stiffness of said shoe 20 is at least 100% greater than the torsional stiffness of a first comparison shoe (not shown). Alternatively, the torsional stiffness of said shoe 20 may be at least 150% greater than the torsional stiffness of the first comparison shoe. Alternatively, the torsional stiffness of said shoe 20 may be 200% greater than the torsional stiffness of the first comparison shoe. Alternatively, the torsional stiffness of said shoe 20 may be at least 250% greater than the torsional stiffness of the first comparison shoe. Alternatively, the torsional stiffness of said shoe 20 may be at least 300% greater than the torsional stiffness of the first comparison shoe. The first comparison shoe is identical to said shoe 20 except the first comparison shoe is devoid of a welt. The torsional stiffness is a torque sufficient to rotate the heel-widest portion 44 ten degrees (10°) from an un-torqued condition as the ball-widest portion 46 is held stationary.

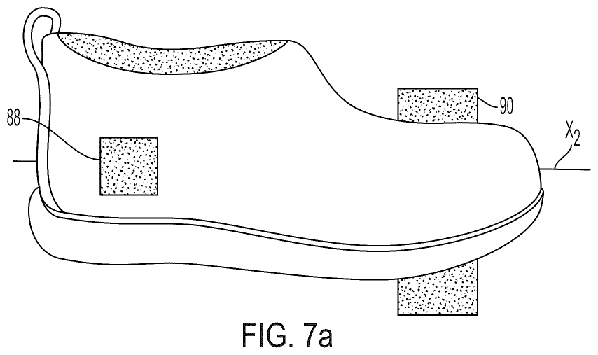

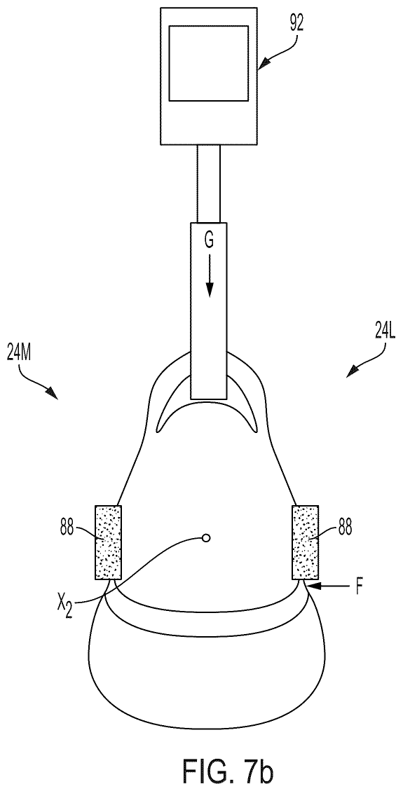

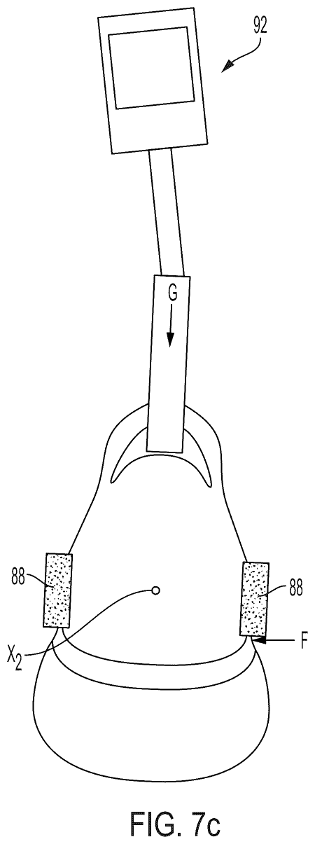

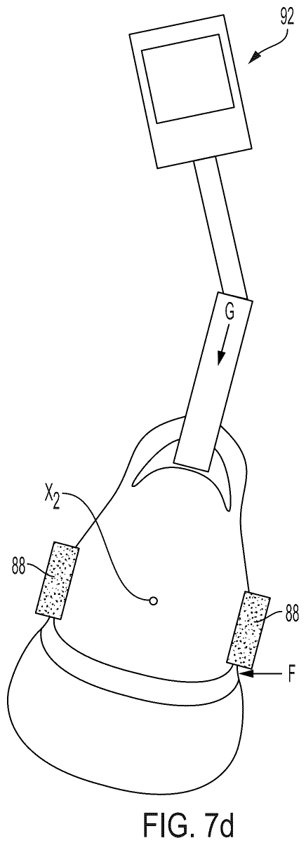

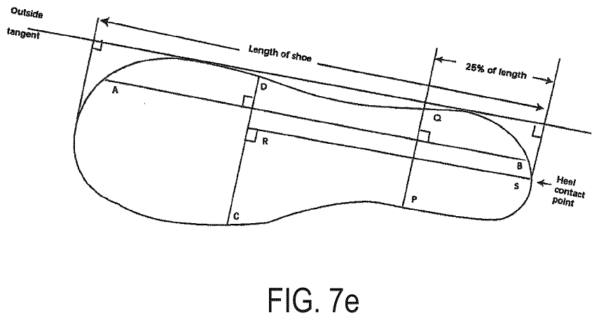

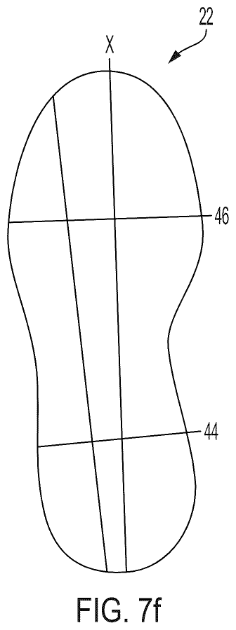

The torsional stiffness may be determined by placing the shoe 20 in a brace such that the ball-widest portion 46 is held stationary (e.g., such as via the heel clamps 88 shown in FIGS. 7a-7d and forefoot clamp 90 as shown in FIG. 7a). The heel clamp 88 is supported (not shown) for rotation about a longitudinal axis X₂ extending through the upper (FIG. 7a, 7b). A torsion force sensor (not shown) may also be operably attached to the heel clamp 88. A 50 Newton downward force G is applied to the sole top surface in the sole heel region. A horizontal-transverse force F is then applied to either a medial side 24M of the upper 24 to generate a torque used in determining the medial torsional stiffness or the lateral side 24L of the upper to generate a torque to determine the lateral torsional stiffness. The force F is applied in a direction perpendicular to the shoe axis X at a point on the upper 24 that is aligned with the heel-widest portion 44 and adjacent the periphery 54. The force F is increased until the heel-widest portion 44 of the shoe 20 rotates ten degrees (10°) from the position before the force is applied (the un-torqued condition). The un-torqued condition is shown in FIG. 7b, a torque resulting in a 5° rotation is shown in FIG. 7c, and a torque resulting in a 10° rotation is shown in FIG. 7d. The angle is measured via an angle monitor sensor 92. This method was performed with a first comparison shoe and a shoe identical to the first comparison shoe but having a welt. As described in greater detail below, this method was also performed with a second comparison shoe and a shoe identical to the second comparison shoe but having a welt and a heel clip. The results of the testing for the former are shown below.

| | Medial | Increase from | Lateral | Increase from |
|---|---|---|---|---|
| | Torsional | First | Torsional | First |
| | Force | Comparison | Force | Comparison |
| Shoe | (Newtons) | Shoe | (Newtons) | Shoe |
| First | 5 | — | 7 | — |
| Comparison | | | | |
| Shoe | | | | |
| Shoe (welt) | 16 | 320% | 16 | 228% |

In the above example, the welt comprised leather. As can be understood from the results, the presence of a welt increases the torsional stiffness at least over 200% as compared to the first comparison shoe.

Referring to FIG. 7e, the PQ marking line is 25% the total length of the shoe to the back of the heel. The CD marking lie is from the salient point f the shoe inside across the AB marking line. To calculate the relevant torque, the distance between lines CD and RQ are measured in millimeters to the nearest 0.5 millimeter. That distance represents the torsional length L of the shoe 20. The torque is then calculated via the equation M=L×F, where M is the torque, L is the torsional length, and F is the force necessary to rotate the shoe 10°.

The upper has an upper heel region 56, an upper midfoot region 58, an upper forefoot region 60, an upper ball region 62, an upper metatarsal region 64, and an upper toe region 66. The sole 22 and upper 24 define a seam 68. The seam 68 has a seam heel region 70 adjacent both the upper heel region 56 and the sole heel region 32. The seam 68 has a seam midfoot region 72 adjacent both the upper midfoot region 58 and the sole midfoot region 34. The seam 68 has a seam forefoot region 74 adjacent both the upper forefoot region 60 and the sole forefoot region 36. The seam 68 has a seam ball region 76 adjacent both the upper ball region 62 and the sole ball region 38. The seam 68 has a seam metatarsal region 78 adjacent both the upper metatarsal region 64 and the sole metatarsal region 40. The seam 68 has a seam toe region 80 adjacent both the upper toe region 66 and the sole toe region 42. The welt extends along and covers the seam heel region 70, the seam midfoot region 72, the seam forefoot region 74, the seam ball region 76, the seam metatarsal region 78, and the seam toe region 80.

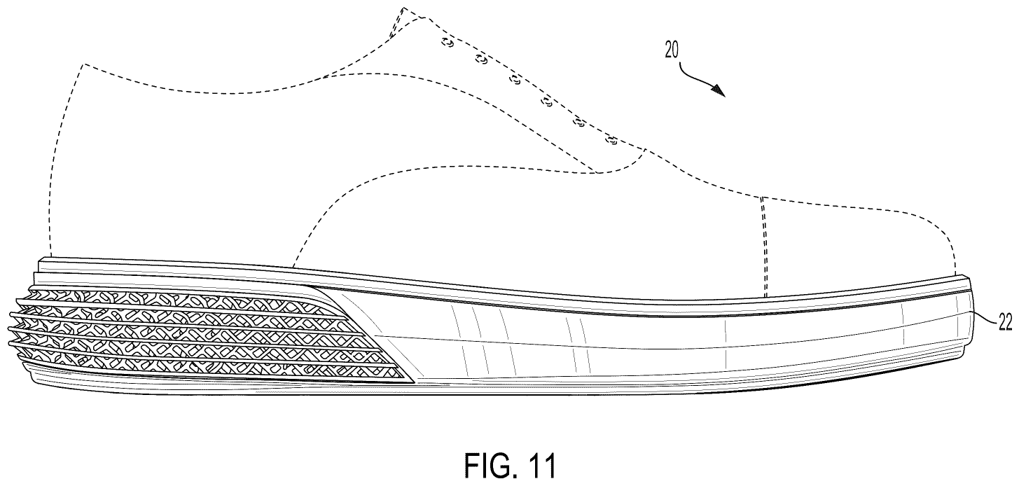

The sole 22 may comprise a midsole 84 and an outsole 86. The midsole 84 and the outsole 86 may be of a unitary construction. For example, the midsole 84 and the outsole 86 may be formed as a single piece via a 3-D printing process. Alternatively, the midsole 84 and outsole 86 may comprise separate components connected together. The connection may comprise adhesive bonding, heat bonding, and the like. If separate components, the outsole may be of a 3-D printed construction or of a molded construction. If the outsole is of a molded construction, it may comprise rubber, thermoplastic polyurethane (TPU), or ethylene vinyl acetate (EVA). As shown in FIG. 11, for example, the midsole 84 may contain components that are of a 3-D printed construction and other components that are of a molded construction. For example, the midsole 84 may comprise a component that is of a 3-D printed construction in the sole heel region 32 and/or the sole midfoot region 34, while the remainder of the midsole 84 may comprise a molded component. The 3-D printed component may be bonded to the molded component by adhesive bonding, heat bonding, or any suitable bonding technique.

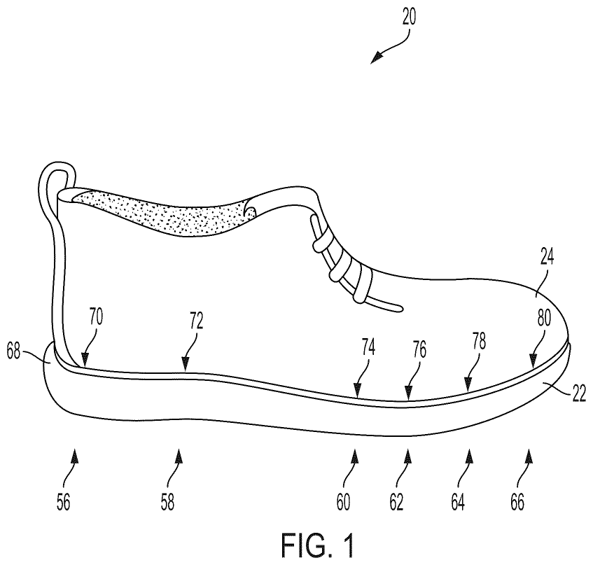

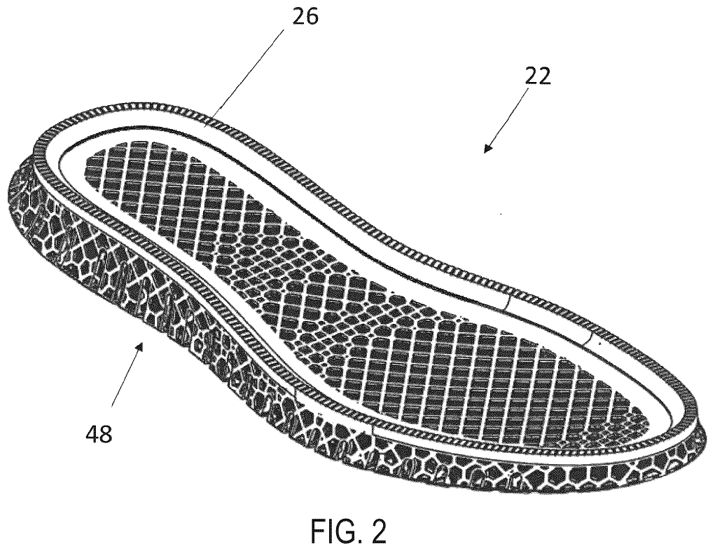

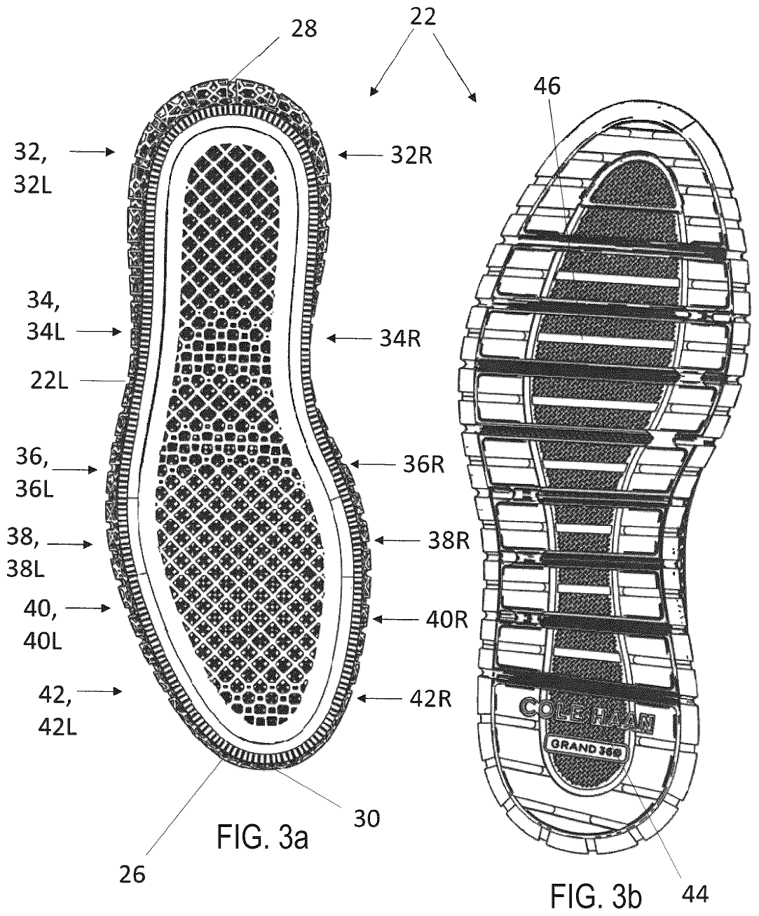

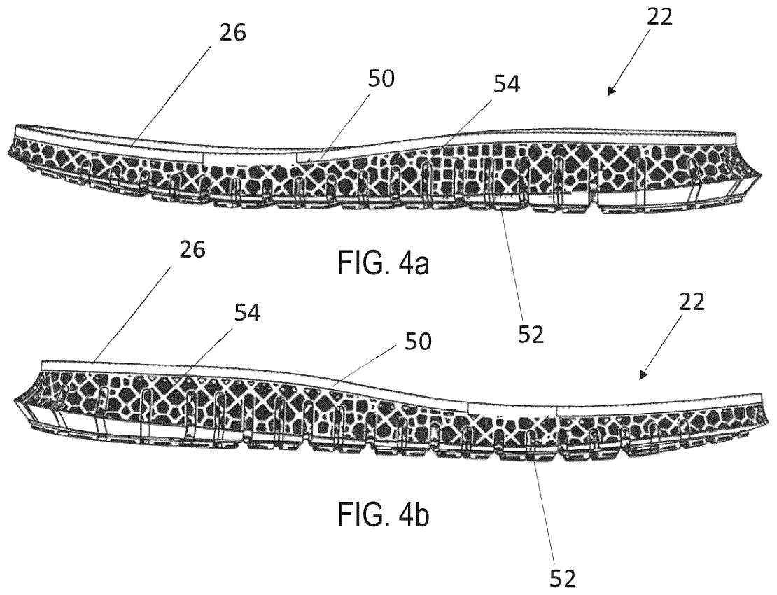

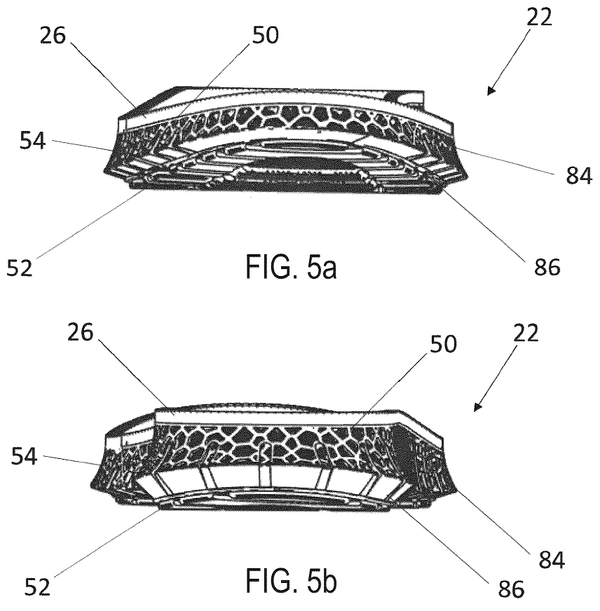

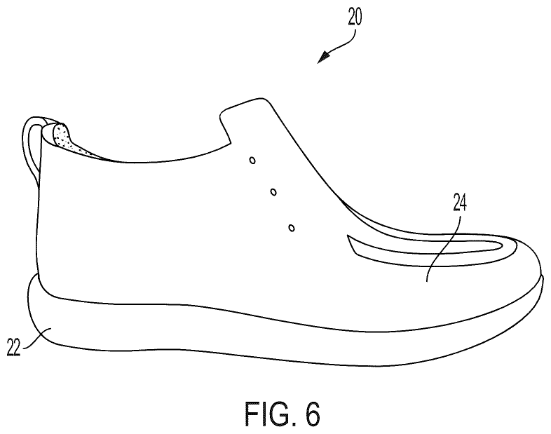

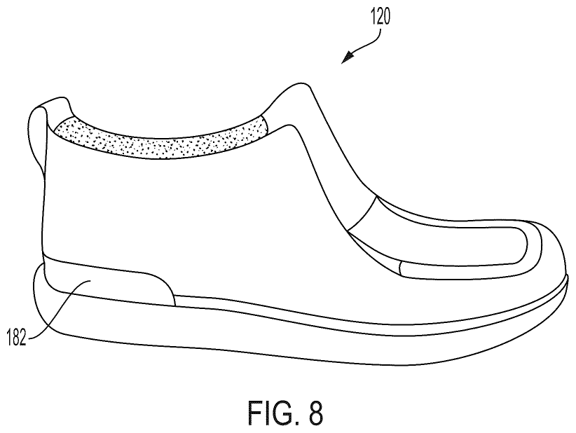

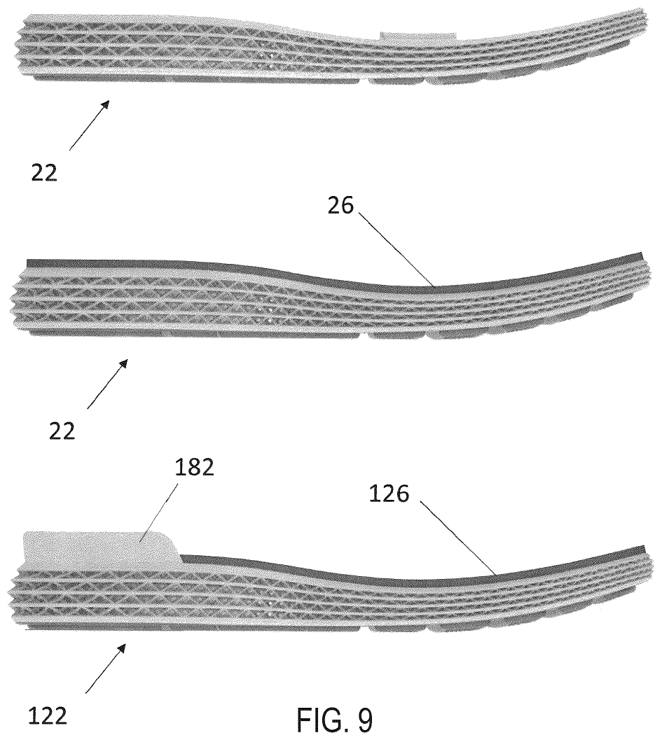

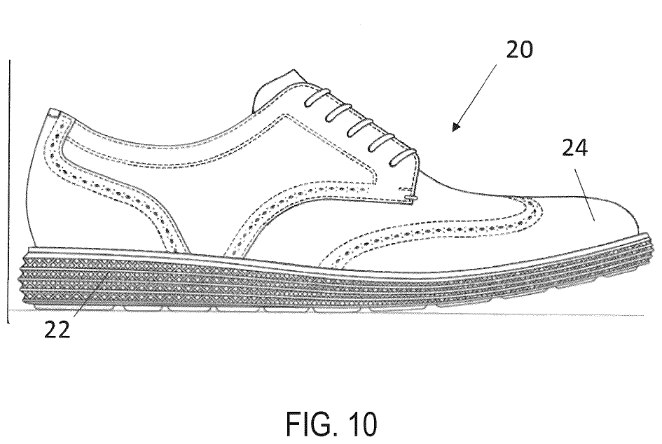

Another embodiment of a shoe, indicated generally at 120, is shown in FIGS. 8-9. The above description of the article of footwear 20 of FIGS. 1-7 applies equally to the article of footwear 120, except for the differences noted in the description of the embodiment of FIGS. 8-9. It is also to be understood that components, elements, features, or regions of the embodiment of FIGS. 8-9 have reference numbers corresponding to the reference numbers of the embodiment of FIGS. 1-7, except the reference numbers of the embodiment of FIGS. 8-9 include a prefix “1.”

The shoe 120 furthers comprise a heel clip 182. The heel clip 182 comprises at least one piece separate from the sole 122, separate from the upper 124, and separate from the welt 126. The heel clip 182 is secured to at least one of the sole 122 and the upper 124 in at least the sole heel region 132.

| | Medial | Increase from | Lateral | Increase from |
|---|---|---|---|---|
| | Torsional | Second | Torsional | Second |
| | Force | Comparison | Force | Comparison |
| Shoe | (Newtons) | Shoe | (Newtons) | Shoe |
| Second | 5 | — | 7 | — |
| Comparison | | | | |
| Shoe | | | | |
| Shoe (welt + | 17 | 340% | 19 | 271% |
| heel clip) | | | | |

In the above example, the welt comprised leather, and the heel clip comprised thermoplastic polyurethane (TPU). As can be understood from the results, the presence of a welt and a heel clip increases the torsional stiffness at least over 300% as compared to the second comparison shoe.

In view of the foregoing, it should be appreciated that the invention has several advantages over the prior art.

It should also be understood that when introducing elements of the present invention in the claims or in the above description of exemplary embodiments of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A shoe comprising:
a sole;
an upper secured to the sole; and
a welt;
the welt comprising at least one piece separate from the sole and separate from the upper, the welt being adjacent both the sole and the upper and being secured to at least one of the sole and the upper;
the sole having a sole heel end and a sole toe end, the sole extending along a shoe axis from the sole heel end to the sole toe end, the sole having a sole heel region, a sole midfoot region, a sole forefoot region, a sole ball region, a sole metatarsal region, and a sole toe region, the sole heel region extending longitudinally from the sole heel end to the sole midfoot region, the sole midfoot region extending longitudinally from the sole heel region to the sole forefoot region, the sole forefoot region extending longitudinally from the sole midfoot region to the sole ball region, the sole ball region extending longitudinally from the sole forefoot region to the sole metatarsal region, the sole metatarsal region extending longitudinally from the sole ball region to the sole toe region, the sole toe region extending longitudinally from the sole metatarsal region to the sole toe end, the sole having a lateral side extending from the sole heel region to the sole toe region and a medial side extending from the sole heel region to the sole toe region, the sole extending transversely from the lateral side to the medial side, the sole heel region having a lateral heel portion and a medial heel portion, the sole midfoot region having a lateral midfoot portion and a medial midfoot portion, the sole forefoot region having a lateral forefoot portion and a medial forefoot portion, the sole ball region having a lateral ball portion and a medial ball portion, the sole metatarsal region having a lateral metatarsal portion and a medial metatarsal portion, the sole toe region having a lateral toe portion and a medial toe portion, the sole having a heel-widest portion, the heel-widest portion being the portion of the sole having the greatest width in the sole heel region from the medial side to the lateral side, the sole having a ball-widest portion, the ball-widest portion being the portion of the sole having the greatest width in the sole ball region from the medial side of the sole to the lateral side of the sole;
the sole being a 3-D printed sole comprising a plurality of interconnected cells, each cell of the plurality of interconnected cells being connected to at least one adjacent cell of the plurality of interconnected cells, the sole having a sole top surface and a sole bottom surface, the sole having a periphery extending between the sole top surface and the sole bottom surface; and
wherein said shoe has a torsional stiffness, the torsional stiffness of said shoe being at least 100% greater than the torsional stiffness of a first comparison shoe, the first comparison shoe being identical to said shoe except the first comparison shoe is devoid of a welt, the torsional stiffness being a torque sufficient to rotate the heel-widest portion ten degrees) (10° from an un-torqued condition as the ball-widest portion is held stationary.

2. The shoe of claim 1 wherein the welt constitutes a single, one-piece member.

3. The shoe of claim 1 wherein the upper comprises an upper heel region, an upper midfoot region, an upper forefoot region, an upper ball region, an upper metatarsal region, and an upper toe region, the sole and upper defining a seam, the seam having a seam heel region adjacent both the upper heel region and the sole heel region, a seam midfoot region adjacent both the upper midfoot region and the sole midfoot region, a seam forefoot region adjacent both the upper forefoot region and the sole forefoot region, a seam ball region adjacent both the upper ball region and the sole ball region, a seam metatarsal region adjacent both the upper metatarsal region and the sole metatarsal region, and a sole toe region adjacent both the upper toe region and the sole toe region; and
wherein the welt extends along and covers the seam heel region, the seam midfoot region, the seam forefoot region, the seam ball region, the seam metatarsal region, and the seam toe region.

4. The shoe of claim 3 wherein the welt is secured to both the sole and the upper.

5. The shoe of claim 3 wherein the welt is bonded to the sole using an adhesive.

6. The shoe of claim 3 wherein the welt comprises leather.

7. The shoe of claim 3 wherein the welt comprises a polymeric material.

8. The shoe of claim 3 wherein the welt comprises ethylene-vinyl-acetate.

9. The shoe of claim 3 wherein the welt comprises thermoplastic polyurethane.

10. The shoe of claim 3 wherein the welt includes a plurality of welt slits.

11. The shoe of claim 3 wherein the welt is a storm welt.

12. The shoe of claim 1 further comprising a heel clip, the heel clip comprising at least one piece separate from the sole, separate from the upper, and separate from the welt, the heel clip being secured to at least one of the sole and the upper in at least the sole heel region.

13. The shoe of claim 1 wherein the torsional stiffness of said shoe is at least 150% greater than the torsional stiffness of said comparison shoe.

14. The shoe of claim 1 wherein the torsional stiffness of said shoe is at least 200% greater than the torsional stiffness of said comparison shoe.

15. The shoe of claim 1 wherein the torsional stiffness of said shoe is at least 250% greater than the torsional stiffness of said comparison shoe.

16. The shoe of claim 1 wherein the torsional stiffness of said shoe is at least 300% greater than the torsional stiffness of said comparison shoe.

17. A shoe comprising:
a sole;
an upper secured to the sole;
a welt; and
a heel clip;
the welt comprising at least one piece separate from the sole and separate from the upper, the welt being adjacent both the sole and the upper and being secured to at least one of the sole and the upper;
the heel clip comprising at least one piece separate from the sole, separate from the upper, and separate from the welt, the heel clip being secured to at least one of the sole and the upper in at least the sole heel region;
the sole having a sole heel end and a sole toe end, the sole extending along a shoe axis from the sole heel end to the sole toe end, the sole having a sole heel region, a sole midfoot region, a sole forefoot region, a sole ball region, a sole metatarsal region, and a sole toe region, the sole heel region extending longitudinally from the sole heel end to the sole midfoot region, the sole midfoot region extending longitudinally from the sole heel region to the sole forefoot region, the sole forefoot region extending longitudinally from the sole midfoot region to the sole ball region, the sole ball region extending longitudinally from the sole forefoot region to the sole metatarsal region, the sole metatarsal region extending longitudinally from the sole ball region to the sole toe region, the sole toe region extending longitudinally from the sole metatarsal region to the sole toe end, the sole having a lateral side extending from the sole heel region to the sole toe region and a medial side extending from the sole heel region to the sole toe region, the sole extending transversely from the lateral side to the medial side, the sole heel region having a lateral heel portion and a medial heel portion, the sole midfoot region having a lateral midfoot portion and a medial midfoot portion, the sole forefoot region having a lateral forefoot portion and a medial forefoot portion, the sole ball region having a lateral ball portion and a medial ball portion, the sole metatarsal region having a lateral metatarsal portion and a medial metatarsal portion, the sole toe region having a lateral toe portion and a medial toe portion, the sole having a heel-widest portion, the heel-widest portion being the portion of the sole having the greatest width in the sole heel region from the medial side to the lateral side, the sole having a ball-widest portion, the ball-widest portion being the portion of the sole having the greatest width in the sole ball region from the medial side of the sole to the lateral side of the sole;
the sole being a 3-D printed sole comprising a plurality of interconnected cells, each cell of the plurality of interconnected cells being connected to at least one adjacent cell of the plurality of interconnected cells, the sole having a sole top surface and a sole bottom surface, the sole having a periphery extending between the sole top surface and the sole bottom surface; and
wherein said shoe has a torsional stiffness, the torsional stiffness of said shoe being at least 100% greater than the torsional stiffness of a second comparison shoe, the second comparison shoe being identical to said shoe except the second comparison shoe is devoid of a welt and devoid of a heel clip, the torsional stiffness being a torque sufficient to rotate the heel-widest portion, about the shoe axis, ten degrees (10°) from an un-torqued condition as the ball-widest portion is held stationary.

18. The shoe of claim 17 wherein the torsional stiffness of said shoe is at least 150% greater than the torsional stiffness of said comparison shoe.

19. The shoe of claim 17 wherein the torsional stiffness of said shoe is at least 200% greater than the torsional stiffness of said comparison shoe.

20. The shoe of claim 17 wherein the torsional stiffness of said shoe is at least 250% greater than the torsional stiffness of said comparison shoe.

21. The shoe of claim 17 wherein the torsional stiffness of said shoe is at least 300% greater than the torsional stiffness of said comparison shoe.

22. The shoe of claim 17 wherein the sole comprises a midsole and an outsole, the midsole being 3-D printed and comprising a plurality of interconnected cells, the outsole being connected to the midsole.

23. The claim of claim 22 wherein the outsole comprises rubber.

24. A shoe comprising:
a sole;
an upper secured to the sole;
the sole having a sole heel end and a sole toe end, the sole extending along a shoe axis from the sole heel end to the sole toe end, the sole having a sole heel region, a sole midfoot region, a sole forefoot region, a sole ball region, a sole metatarsal region, and a sole toe region, the sole heel region extending longitudinally from the sole heel end to the sole midfoot region, the sole midfoot region extending longitudinally from the sole heel region to the sole forefoot region, the sole forefoot region extending longitudinally from the sole midfoot region to the sole ball region, the sole ball region extending longitudinally from the sole forefoot region to the sole metatarsal region, the sole metatarsal region extending longitudinally from the sole ball region to the sole toe region, the sole toe region extending longitudinally from the sole metatarsal region to the sole toe end, the sole having a lateral side extending from the sole heel region to the sole toe region and a medial side extending from the sole heel region to the sole toe region, the sole extending transversely from the lateral side to the medial side, the sole heel region having a lateral heel portion and a medial heel portion, the sole midfoot region having a lateral midfoot portion and a medial midfoot portion, the sole forefoot region having a lateral forefoot portion and a medial forefoot portion, the sole ball region having a lateral ball portion and a medial ball portion, the sole metatarsal region having a lateral metatarsal portion and a medial metatarsal portion, the sole toe region having a lateral toe portion and a medial toe portion;
the sole comprising a midsole and an outsole, the midsole having a first portion and a second portion, the first portion being a 3-D printed portion comprising a plurality of interconnected cells, each cell of the plurality of interconnected cells being connected to at least one adjacent cell of the plurality of interconnected cells, the second portion being of a molded construction.

25. The shoe of claim 24 wherein the first portion is within the sole heel region and wherein the second portion is within one or more of: the sole midfoot region, the sole forefoot region, the sole ball region, the sole metatarsal region, and the sole toe region.
